(19) United States
(12) Patent Application Publication
(10) Pub. No.: US 2026/0274348 A1
(43) Pub. Date: Sep. 17, 2026

(54) FRONT PART OR REAR PART OF A VEHICLE WITH AT LEAST TWO WHEELHOUSE ELEMENTS AND AT LEAST ONE CROSS-MEMBER CONNECTING THE WHEELHOUSE ELEMENTS, AND METHOD FOR PRODUCTION

(71) Applicants: Volkswagen Aktiengesellschaft, Wolfsburg (DE); MAN Truck & Bus SE, Munich (DE)

(72) Inventors: Michael TROITZSCH, Geestland (DE); Thorsten GLAESNER, Paderborn (DE)

(73) Assignees: Volkswagen Aktiengesellschaft, Wolfsburg (DE); MAN Truck & Bus SE, Munich (DE)

(21) Appl. No.: 19/676,030

(22) Filed: May 13, 2026

Related U.S. Application Data
(63) Continuation of application No. PCT/EP2024/081563, filed on Nov. 7, 2024.

(30) Foreign Application Priority Data
Nov. 14, 2023 (DE) 10 2023 131 672.9

(51) Int. Cl. B62D 25/18; B62D 21/03; B62D 29/00

(52) U.S. Cl. CPC B62D 25/18; B62D 21/03; B62D 29/007

(57) ABSTRACT

A front part or rear part of a vehicle with at least two wheelhouse elements and at least one cross-member connecting the wheelhouse elements, which form a main body made of a lightweight metal material. At least one reinforcement element, formed from an expanded metal or a metal blank, is embedded by casting in at least one wheelhouse element and/or in the cross-member. A method for producing such a front part or rear part is also provided.

This nonprovisional application is a continuation of International Application No. PCT/EP2024/081563, which was filed on Nov. 7, 2024, and which claims priority to German Patent Application No. 10 2023 131 672.9, which was filed in Germany on Nov. 14, 2023, and which are both herein incorporated by reference.

### BACKGROUND OF THE INVENTION

### Field of the Invention

The invention relates to a front part or rear part of a vehicle having at least two wheelhouse elements and at least one cross-member connecting the wheelhouse elements, which form a main body. In particular, the invention relates to a front part or rear part of a motor vehicle having a vehicle weight of up to 2.8 metric tons, a light commercial vehicle having a weight of more than 2.8 metric tons, in particular more than 3.5 metric tons, or a heavy commercial vehicle greater than 7.5 metric tons. Reference is also made to vehicles having a correspondingly designed front part or rear part, in particular, to motor vehicles and specifically to commercial vehicles having a front part or rear part of this type. The invention further relates to a method for manufacturing a front part or rear part of this type.

### Description of the Background Art

In the past, vehicle bodies and chassis structures were frequently manufactured from a multiplicity of individual parts, which were glued, welded, or screwed to each other. In the more recent past, a trend arose to simplify manufacturing processes in that larger body elements and structures were manufactured from large cast parts. One challenge in this connection is that highly stressed force application points of components of this type must withstand the stresses occurring not only when operating the vehicle as intended but also in crash situations so as to not have any disadvantages with regard to crash safety compared to conventionally manufactured vehicle bodies and structures. Up to now, this aspect has been taken into account by using a suitable material in the particular component, for example a high-strength steel. However, this procedure is cost-intensive, in particular when it comes to a large cast component which must only partially have a high rigidity.

Alternatively, it is known to provide regions with a partially rigid design in that a suitable geometry or material accumulation is provided. However, this is, in part, difficult or even impossible in terms of casting technology, or in the case of material accumulation, it is associated with an additional weight and corresponding disadvantages in the driving power and fuel consumption of the particular vehicle.

It is furthermore known from FR 2 558 084 A1 to provide a cast element having an insert to partially increase the rigidity. However, FR 2 558 084 A1 makes no reference to either large cast components or to a main element of a front part or rear part having cross-members, as described above.

A cast component for a body structure of a vehicle is known from DE 10 2022 000 631 A1, which comprises a separately manufactured metal insert part, which is connected to a die-cast part by means of die casting. The metal insert part is partially overmolded by the die-cast part. In a method described in this publication for manufacturing a composite component, the metal insert part is to be austenitized prior to being placed into the die-casting mold, and the metal insert part heated by the austenitization is to be placed into the die-casting mold to be finally formed in the die-casting mold by the inflowing die-casting melt and to be hardened by cooling in the die-casting mold. However, this publication also makes no reference to either large cast components or to a main element of a front part or rear part having cross-members, as described above.

A component and a method for manufacturing a component are known from DE 10 2018 213 490 A1. The component is to comprise at least two elements, a first element being embedded into a second element, in regions, the first element having or forming a boundary layer, and, in a direction of which the first element infiltrates the second component, a transition zone is formed. The component is to be, in particular, a die-cast component made from aluminum, into which a steel insert is cast. This publication also makes no reference to either large cast components or to a main element of a front part or rear part having cross-members, as described above.

### SUMMARY OF THE INVENTION

It is therefore an object of the invention to provide a front part or rear part of a vehicle as well as a method for manufacturing a front part or rear part of this type, which may be manufactured as a large cast part and have an increased crash safety.

A front part or rear part of a vehicle according to the invention has a main body, which is formed from at least two wheelhouse elements and at least one cross-member connecting the wheelhouse elements. The main body is manufactured from a lightweight metal material. In addition, at least one reinforcement element formed from an expanded metal or a metal blank is embedded by casting in at least one wheelhouse element and/or in the cross-member of the main body. A lightweight metal material within the meaning of the invention is understood to be, in particular, aluminum or magnesium. Metal materials which have a higher strength than the lightweight metal material are particularly suitable as the metal material. At least one of the strengths of tensile strength, compressive strength, flexural strength, or torsional strength of the reinforcement element is preferably higher than the particular strength of the lightweight metal material, preferably the tensile strength and/or the compressive strength, and independently thereof, at least two or three of the aforementioned strengths of the material of the reinforcement element are preferably higher than that of the lightweight metal material. As explained below with the aid of further technical details, a main body of this type may be manufactured as a large cast part, the crash safety being increased with the aid of the reinforcement element embedded by casting. The weight may be reduced—in comparison to a main body manufactured exclusively as a single piece from the lightweight metal material—because the material accumulations mentioned at the outset may be dispensed with.

In an example of a front part or rear part according to the invention, the at least one reinforcement element can be manufactured from a material which undergoes a strength-increasing effect when heated by contact with a liquid lightweight metal when using a casting method for manufacturing the main body and a subsequent cooling. In particular, what is meant by the casting method is, for example, an aluminum casting method or a magnesium casting method. If the above technical condition is met, a material may be selected for the reinforcement element which has a relatively soft state in the basic state, i.e., prior to embedding in the main body, so that a good deformability is ensured. This may be used, in particular, to place the reinforcement element into a suitable form, in particular bent into shape. The strength-increasing effect sets in by means of the embedding by casting and the associated heating and subsequent cooling, so that the reinforcement element has the desired increased strength only during or after the manufacturing of the main body. In this respect, what is meant by the strength mentioned above is the strength of the reinforcement element which is present after the main body, including the embedded reinforcement element, is manufactured. In the case last mentioned, this strength is also increased compared to the strength of the reinforcement element prior to the embedding in the main body. What is meant by the cooling of the main body is, in particular, a cooling of the main body to the ambient temperature after a manufacturing by casting, in particular a temperature between approximately 15° C. and 25° C., for example, 20° C.

The at least one reinforcement element can be manufactured from an air-hardened steel and/or from a medium manganese steel. This is a steel having a manganese content of, for example, approximately 4% to 12%.

With respect to air-hardened steels, reference is made, in particular, to the materials Salzgitter Flachstahl LH®900 and RobuSaI®800. In connection with these materials, reference is also made explicitly to the material compositions and parameters found, in particular, at https://www.salzgitter-flachstahl.de/fileadmin/footage/MEDIA/gesellschaften/szfg/ informationsmaterial/produktinformationen/kaltgewalztes_feinblech/deu/lh900.pdf and at https://www.salzgitter-flachstahl.de/fileadmin/footage/MEDIA/gesellschaften/szfg/ informationsmaterial/produktinformationen/warmgewalzte_produkte/deu/ robusal_r_800.pdf, which are attached hereto as appendixes to the specification, with their corresponding English versions, and whereby all of which are incorporated herein by reference.

The reinforcement element can be manufactured from a material which undergoes a strength-increasing effect in contact with a liquid lightweight metal material having a temperature of approximately 600° C. to 1,000° C. and subsequent cooling. It is furthermore advantageous if the strength-increasing effect sets in within the temperature range between 600° C. and 800° C., in particular in a range between 700° C. and 750° C. After all, liquefied lightweight metal materials have temperatures of this type during the casting process, in particular, aluminum processed in the aluminum casting process. Medium manganese steels, combined with a main body made from an aluminum material, are particularly suitable in this example.

If the at least one reinforcement element is an expanded metal, which can be formed by introducing cuts into a metal sheet and bending and/or stretching the material strips resulting from the cuts alternately in opposite directions—in particular, upwardly and downwardly—the resulting main body has very high rigidity, which is specific to weight and is thus advantageous for crash requirements. The introduction of a reinforcement element formed from an expanded metal is therefore particularly preferred.

In a front part or rear part according to the invention, the at least one reinforcement element may alternatively or additionally also be a flat element extending over a large portion of the width of the at least one cross-member, and/or a curved element extending at least over a curved subsection of a wheelhouse element.

If the reinforcement element extends over a large portion of the width of the cross-member, in particular, over more than 60 percent, preferably more than 70 percent, more than 80 percent, or more than 90 percent of the width between the insides of the wheelhouse elements, a high transverse rigidity of the main body results, with the aid of which the passenger cell may be provided with an increased rigidity in this region, in particular, in the event of a side impact. If the wheelhouse elements are provided with a corresponding reinforcement element, the transverse rigidity may be—in particular, additionally—increased, and the dimensional stability of the wheelhouse carrier may also be increased, so that upon the application of forces acting directly upon a wheelhouse, the probability is high that the shape of the wheelhouse is retained in such a way that no contact exists between the wheelhouse and a vehicle wheel, so that a vehicle remains drivable even after a collision.

The at least one reinforcement element can be embedded over the entire area, at least on one side, via which a connection to the main body results over a wide area, and a detachment or shearing off of the reinforcement element is unlikely during a crash. The at least one reinforcement element is preferably completely embedded in the main body, so that the reinforcement element is protected as best as possible against outer influences and a separation during a crash. In this respect, an arrangement within the main body approximately in the center with respect to the thickness of the main body is preferred. If an eccentric arrangement of the reinforcement element is provided, it is possible to arrange the reinforcement element more in the direction of the vehicle outside as well as more in the direction of the vehicle inside. The arrangement more in the direction of the vehicle inside has the advantage that the reinforcement element is protected as best as possible against external applications of force due to intrusion forces of crash partners. The arrangement in the direction of the vehicle outside has the advantage that intrusion forces initially strike the reinforcement element having a higher strength, so that the forces are guided from this harder element onto the main body, which follows essentially farther to the inside of the vehicle. If a detachment of the reinforcement element from the main body is not to be feared, due to a connection of sufficient load-carrying capacity and the geometrical design of the reinforcement element (for example, essentially covering the entire surface of the outside of the main body), an arrangement of the reinforcement element on the main body outside the vehicle is to be preferred from a crash perspective.

With respect to lightweight construction aspects as well as with respect to a secure connection between the reinforcement element and the main body, the reinforcement element in a front part or rear part according to the invention can have through-openings, which are designed in such a way that they are completely filled with the lightweight metal material after the embedding by casting. In this case, the reinforcement element has a reduced weight, due to the through-openings. In addition, a very good and load-bearing connection occurs between the reinforcement element and the main body, since in each case the main body penetrates the connection element in the region of the through-openings, so that a large contact surface area and a good “meshing” take place overall between the reinforcement element and the main body.

The invention also relates to a method for manufacturing a front part or rear part as described above, according to which the reinforcement element can be held with the aid of supporting structures made from the lightweight metal material, and the main body can then be manufactured from a lightweight metal material by at least partially overmolding the reinforcement element, the supporting structures being melted on with a delay during the overmolding only when the reinforcement element is fixed in its relative position within the front part or rear part by means of already hardened lightweight metal. This may be effectuated, for example, in that the supporting structures are provided on the underside, while the casting takes place predominantly from the upper side, in particular, in such a way that the casting mold is first filled from the upper side than also from the underside only toward the end of the casting process. After all, the flow speed decreases rapidly as soon as the casting mold is largely filled, so that the flow around the supporting structures may take place in a time-delayed manner if the casting mold and the pour-in point(s) is/are selected in such a way that the liquid lightweight metal reaches the region having the supporting structures only toward the end of the filling of the casting mold.

Also, for manufacturing a front part or rear part as described above, the reinforcement element can be held with the aid of casting cores, which are expended or ejected after the casting process. In the case of an ejection, the casting process may be provided with a largely arbitrary design. If expendable cores are used, similar conditions must be met as in the method described above, in which the supporting structures are melted on. In this case, through-openings which permit a visual contact with the reinforcement element remain in the region of the expendable cores after manufacturing. This may be advantageous if the material state of the reinforcement element is to remain able to be inspected by means of visual inspection and/or material inspection techniques which require direct access to the reinforcement element.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a section of a vehicle having a rear part according to the invention, the embedded reinforcement element being illustrated by a dashed line;

FIG. 2 shows a section of a reinforcement element designed as expanded metal;

FIG. 3 shows a section of a reinforcement element designed as a perforated plate; and

FIG. 4 shows a schematic representation of a casting mold having supporting structures for supporting a reinforcement element during the manufacturing by casting of a front part or rear part according to the invention.

### DETAILED DESCRIPTION

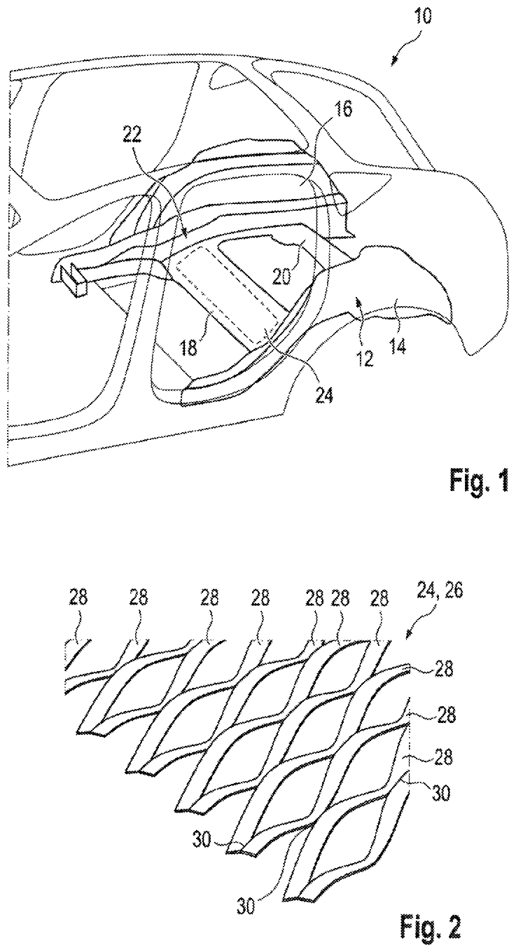

FIG. 1 shows a section of a vehicle 10 having a rear vehicle part 12, and is formed from a first wheelhouse element 14 and a second wheelhouse element 16, which each extend in a curved manner over a wheelhouse section on an outside of vehicle 10. Wheelhouse elements 14, 16 in the illustrated example are connected to each other via a first cross-member 18 and a second cross-member 20 to form a main body 22.

In the example shown in FIG. 1, a reinforcement element 24, illustrated by a dashed line, is embedded in first cross-member 18 and is situated completely within first cross-member 18 and is therefore illustrated by the dashed line.

Main body 22 has been manufactured from aluminum in an aluminum casting process. In the illustrated example, reinforcement element 24 is completely embedded by casting in first cross-member 18. Reinforcement element 24 extends over the entire width between the first and second wheelhouse elements 14, 16.

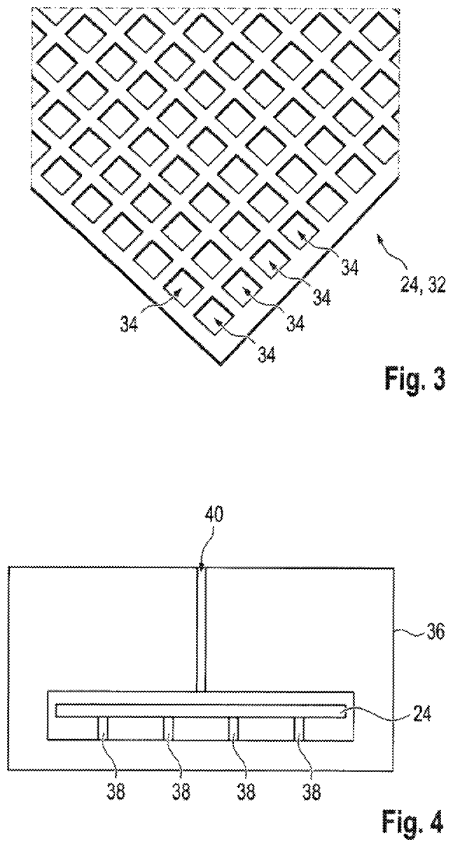

FIGS. 2 and 3 Show Further Examples of Different Reinforcement Elements 24.

In the example illustrated in FIG. 2, reinforcement element 24 is formed from an expanded metal 26. Expanded metal 26 is formed from multiple material strips 28, which are separated from each other by alternately bending and stretching material strips 28 in different directions, in this case, upwardly and downwardly. To manufacture expanded metal 26, slits of approximately equal length are provided in each case, by which means material strips 28 are formed. So-called nodes 30 are in the regions in which no slit is provided between material strips 28.

FIG. 3 shows a reinforcement element 24 in the form of a perforated plate 32, Perforated plate 32 has a multiplicity of through-openings 34, which are provided with a square design in the illustrated example. However, it is also possible to provide through-openings 34 in different shapes, in particular, in circular, oval, rectangular, polygonal, or other shapes.

FIG. 4 shows a schematic representation of a casting mold 36, including supporting structures 38 for supporting a reinforcement element 24 during the manufacturing by casting. Casting mold 36 has a pour-in section 40, which is arranged on the upper side. Liquid metal, in particular liquid aluminum, flows into casting mold 36 via pour-in section 40 and flows around reinforcement element 24.

The liquid metal reaches supporting structures 38 only toward the end of the casting process when casting mold 36 is already largely filled with liquid metal. In particular, supporting structures 38 may be manufactured from metallic casting material, so that supporting structures 38 are melted on by the identical liquid metal after reinforcement element 24 is already being held by solidified material on the upper side, laterally, and, in part, on the underside.

Alternatively, supporting structures 38 may also be designed as expendable cores or as ejectable cores, which are removed after the casting process. In the latter case, through-openings, which permit a direct visual contact of and access to supporting reinforcement element 24 even after the manufacturing of the front part or rear part, remain in the region of supporting structures 38 after ejection and removal of the cores.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A front part or rear part of a vehicle comprising:
at least two wheelhouse elements;
at least one cross-member connecting the wheelhouse elements to thereby form a main body made from a lightweight metal material; and
at least one reinforcement element formed from an expanded metal or a metal blank, the at least one reinforcement element being embedded by casting in at least one of the at least two wheelhouse elements and/or in the cross-member.

2. The front part or rear part according to claim 1, wherein the at least one reinforcement element is manufactured from a material that undergoes a strength-increasing effect when heated by contact with liquid lightweight metal during the application of a casting process and subsequent cooling.

3. The front part or rear part according to claim 1, wherein the at least one reinforcement element is manufactured from an air-hardened steel and/or from a medium manganese steel.

4. The front part or rear part according to claim 1, wherein the reinforcement element is manufactured from a material which undergoes a strength-increasing effect in contact with a liquid lightweight metal material having a temperature of approximately 600° C. to 1,000° C. and subsequent cooling.

5. The front part or rear part according to claim 1, wherein the at least one reinforcement element is an expanded metal, which is formed by introducing cuts into a metal plate and by bending and/or stretching the resulting material strips alternately in opposite directions.

6. The front part or rear part according to claim 1, wherein the at least one reinforcement element is a flat element extending over a large part of the width of the at least one cross-member and/or a curved element extending at least over a curved subsection of a wheelhouse element.

7. The front part or rear part according to claim 1, wherein the at least one reinforcement element is embedded over the entire surface, or wherein the at least one reinforcement element is completely embedded at least on one side so that it is arranged completely within the main body.

8. The front part or rear part according to claim 1, wherein the reinforcement element has through-openings that are designed such that they are completely filled by the lightweight metal material after the embedding by casting.

9. A method for manufacturing, the method comprising:
providing a front part or rear part according to claim 1;
holding the reinforcement element with the aid of supporting structures made from the lightweight metal material; and
manufacturing the main body from the lightweight metal material by at least partially overmolding the reinforcement element, the supporting structures being melted on with a delay during the casting only when the reinforcement element is fixed in a relative position within the front part or rear part via an already hardened lightweight metal.

10. A method for manufacturing, the method comprising:
providing a front part or rear part according to claim 1; and
holding the reinforcement element with the aid of casting cores, which are expended or ejected after the casting process.
